(19) United States
(12) Patent Application Publication
(10) Pub. No.: US 2018/0048754 A1
(43) Pub. Date: Feb. 15, 2018

(54) PHOTOGRAPHIC DEVICE AND ASSOCIATED METHOD FOR IMPROVING THE CAPTURE OF A SELFIE

(71) Applicant: KEZAPONT, Colombes (FR)

(72) Inventor: Philippe PONT, Colombes (FR)

(73) Assignee: KEZAPONT, COLOMBES (FR)

(21) Appl. No.: 15/553,784

(22) PCT Filed: Feb. 26, 2016
(86) PCT No.: PCT/FR2016/050444

§ 371 Date: Sep. 13, 2017

(30) Foreign Application Priority Data
Feb. 27, 2015 (FR) 15 00378

(51) Int. Cl. H04M 1/725; H04N 5/335; H04M 1/18

(52) U.S. Cl. CPC H04M 1/72527; H04M 1/185; H04N 5/335; H04M 2250/52; H04N 7/14

(57) ABSTRACT

Disclosed is a photographic device including: a cell phone or a tablet equipped with a screen associated with a device for displaying an image on the screen; an image capturing device configured to capture an image along an optical axis and to transmit this image to the device for displaying an image; a mirror surface configured to be able to be placed facing the screen so as to reflect an image displayed on the screen, the mirror surface being suitable for allowing an image to be captured by the image-capturing device through a central portion of the mirror surface. Also disclosed is an associated image-capturing method.

The present invention relates to a photographic device. The present invention is more particularly aimed at a device for acquiring an image of a subject by means of a cellular telephone or of a tablet, or else of any other digital device of the same type, such as notably a portable computer. The present invention is also aimed at a method for capturing a photographic image where the subject uses said photographic device.

It is increasingly common to take ones own photo by means of a cellular telephone in order to produce self-portraits, notably known as “selfies”, with a camera integrated into a cellular telephone, notably with a cellular telephone known as a “smartphone”. Usually, the camera is integrated into the cellular telephone and is generally disposed above the screen of the cellular telephone. Such photos may also be taken with a tablet, also known as a “digital tablet” or “touchscreen tablet”. It is observed that the subject tends to look at the screen in order to see themselves while taking the photo and that they do not look directly into their eyes. This results in selfies that are not very flattering. Indeed, with the current devices, the subject looks at themselves with their eyes shifted because, by looking at themselves on the screen, they do not look at the camera lens which is not located in the center of the screen, but their gaze is shifted with respect to the axis of the lens. The subject has the possibility of adjusting their gaze by guess-work so as to have their gaze roughly centered but then they cannot improve their expression because they cannot see themselves directly, whereas this point is important for achieving a flattering selfie, the gaze playing a significant role in achieving a pleasing picture. If this approximate correction “by guess-work” is not made, by looking at their image on the screen, they will have a gaze looking elsewhere than toward the camera lens creating a sidelong glance (not into the eyes) which, for portrait photographs, remains unaesthetic and lacking expression and, above all, not interactive.

The present invention aims to solve this consequent technical problem and consists in obtaining flattering selfies, notably with a technical solution that is simple to implement.

For this purpose, the present invention is aimed at a photographic device comprising:
a cellular telephone or a tablet equipped with a screen associated with a device for displaying an image on said screen;
an image capture device configured for capturing an image along an optical axis and for transmitting this image to the device for displaying an image;
a mirror surface configured so as to be able to be disposed facing the screen in such a manner as to reflect an image displayed on the screen, said mirror surface being designed to allow an image to be captured by the image capture device through a central part of the mirror surface.

Such a device allows flattering selfies to be obtained because, using it, the subject can look at their own image in order to see themselves when the image is captured while looking at themselves directly in the eyes. Furthermore, such a device is simple to implement and may be fabricated with inexpensive components.

The present invention is also aimed at a photographic device furthermore comprising the features described in the following embodiments, which may be combined together according to all the solutions that may be technically envisioned:
the mirror surface capable of being positioned facing the screen is disposed on a mobile part attached to the cellular telephone or to the tablet via an articulation device;
the mobile part attached to the cellular telephone or to the tablet is a flap of a protection case into which the cellular telephone or the tablet is inserted;
the mirror surface capable of being positioned facing the screen is obtained by a partially transparent reflecting layer, for example the reflecting surface of a one-way mirror;
the mirror surface capable of being positioned facing the screen is obtained by a reflecting layer through which an opening is formed in such a manner as to allow an image to be captured through said opening by virtue of an image capture device;
the mirror surface has substantially the size of the screen, for example the mirror surface has a surface area in the range between 80% and 120% of the surface area of the screen;
the mirror surface has a rectangular shape with a width, Larg, and a length, Long, and where the central part of the mirror surface is bounded by a rectangle centered on the point (Larg/2, 2·Long/3) and with a width of the short side equal to Larg/2 and with a length of the long side equal to Long/2;
the optical axis (AO) of the image capture device is situated between 30° and 60° from the normal to the mirror surface;
the image capture device is associated with a displacement device allowing the image capture device and/or the optical axis of the image capture device to be oriented;
the photographic device comprises a device for angular separation between the screen and the mirror surface, designed to allow an angular separation, α, between the screen and the mirror surface, in the range between 30° and 60°.

According to one embodiment, the device consists in incorporating into a protection case for a cellular telephone (smartphone or tablet) a one-way mirror or a mirror perforated in its center on the flap of the protection case (also referred to as “the protection cover”) which covers the screen of the telephone or on a flap integrated into the device which then opens like a book (or tablet) and in adding to it a camera or miniature camera lens (behind the one-way mirror) which communicates the image to the cellular telephone.

In this embodiment, the image of the subject is therefore seen by the image capture device through the “one-way mirror+camera lens” or “perforated mirror+camera lens” device; it is transmitted and displayed on the screen of the cellular telephone and subsequently reflected in the mirror in order to be seen by the subject with a centered gaze. This allows the subject to look at themselves directly in the eyes and to produce better selfies. The angle of opening of the flap may be positioned in a predetermined fashion (for example by means of a blocking or notching system) so as to obtain an adjustment which allows the reflection of the screen retransmitting the photographed image to be seen in the mirror and so that the subject can look at it under the best conditions.

According to one embodiment, the image of the subject is displayed by a smartphone and it is captured by a camera lens of a camera which is located behind a one-way mirror or in the center of a mirror perforated in the middle. The one-way part does not in fact need to cover the whole of the surface; it may have the same dimensions as the image capture device on the back and it may be envisioned for the remainder of the reflecting surface to just be a simple mirror which could for example reduce the production costs.

According to one embodiment, protection cases for cellular telephones or tablets can be fabricated, equipped with an image capture device so as to obtain a device according to the present invention. Such a protection case opens like a book (for example with an angle of around 45 degrees) and is fitted with a one-way mirror (or with a simple mirror perforated in its center) on the face opposite to the image displayed on the cellular telephone or other digital image devices. It is thus possible for the image capture device to see the subject, to transmit it a telephone inserted into this protection case and for the image from the telephone to be reflected in the one-way mirror of the flap or of the protection case. According to one embodiment, it is a simple mirror bonded onto a protection flap of a telephone which comprises a one-way reflection surface, where the one-way surface is situated in the axis of the image capture device. The one-way surface has for example dimensions that are equivalent to or slightly larger than the image capture device situated on the back of the flap and which sees the subject through the opening formed in this same flap; in this case, the opening is itself covered by the one-way part.

According to one embodiment, a photographic device according to the invention, for acquiring the image of a subject by means of a smartphone or of a touchscreen tablet, allows the subject to take a photo of themselves (selfies), and gives them the possibility of looking at themselves directly in the eyes through the lens of a camera, placed on the back of a protection flap of the smartphone or of the tablet at eye level. Such a device comprises:
a mirror surface configured so as to be able to be disposed facing the screen in such a manner as to reflect an image displayed on the screen, this mirror surface being a one-way mirror positioned in the opening of the flap of protection or on the latter; the flap covers the screen of the telephone or of the tablet; the angle of opening of the flap (a) may be positioned in a predetermined fashion (blocking or notching system) at a predetermined angle;
an image capture device on the back of the one-way mirror which transmits the image of the subject to the telephone or tablet; said image capture device is configured for capturing an image along an optical axis (AO) and for transmitting this image to the device for displaying an image;
a display device, notably a screen of a cellular telephone or of a tablet for displaying the image of the subject transmitted by the image capture device;
a wired link from the image capture device to the cellular telephone or of the tablet which transmits the image from the image capture device; the link may also be wireless using Wifi, Bluetooth, etc.;
a trigger placed at the bottom of the flap but able to be placed on another part of the flap or on the cellular telephone itself.

The present invention is also aimed at a method for capturing a photographic image where a subject uses a photographic device such as previously described and where:
the image capture device captures an image of the subject and transmits this image to the device for displaying an image;
the image is displayed by the display device on the screen;
the mirror surface is disposed facing the screen in such a manner as to reflect the image of the subject displayed on the screen.

According to various embodiments of the method of the present invention, which may be combined together according to all the solutions that may be technically envisioned:
the image of the subject captured by the image capture device comprises the eyes of the subject;
the gaze of the subject is directed towards the mirror surface;
the average gaze line of the subject and the optical axis (OA) of the image capture device are separated by an angle less than or equal to 15°;
the image displayed by the display device on the screen is a mirror image of the image captured by the image capture device.

The invention will be better understood if reference is made to the appended drawings, where:

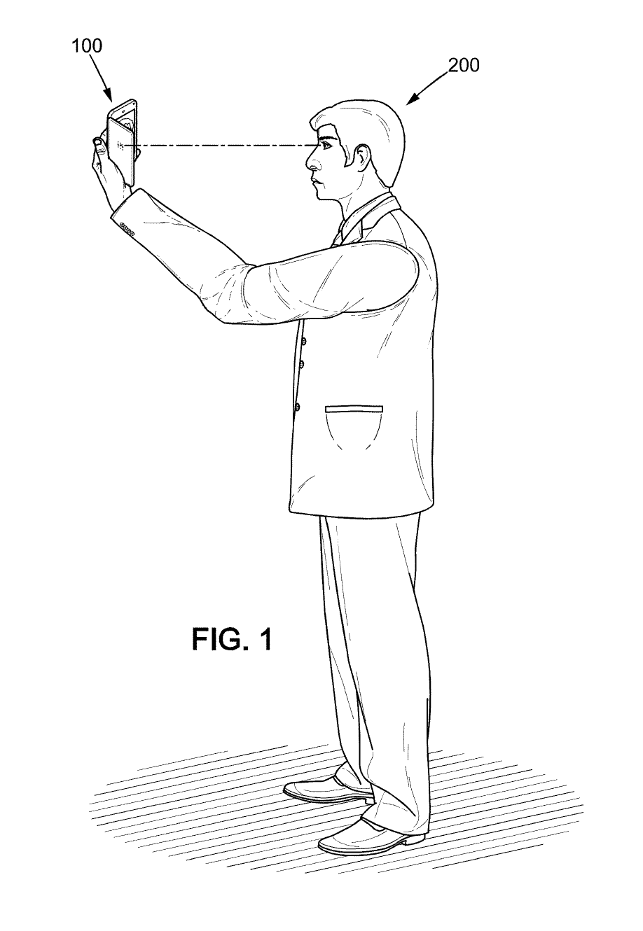

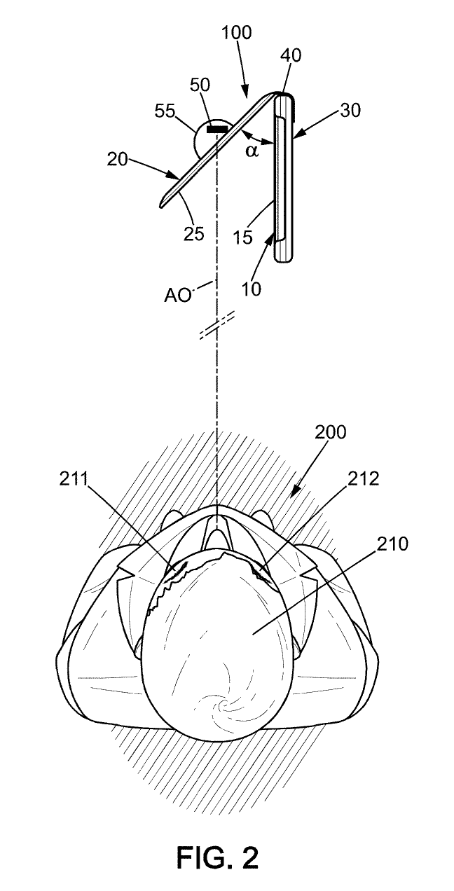

FIGS. 1 and 2 show one embodiment of a photographic device according to the invention, implemented by a subject;

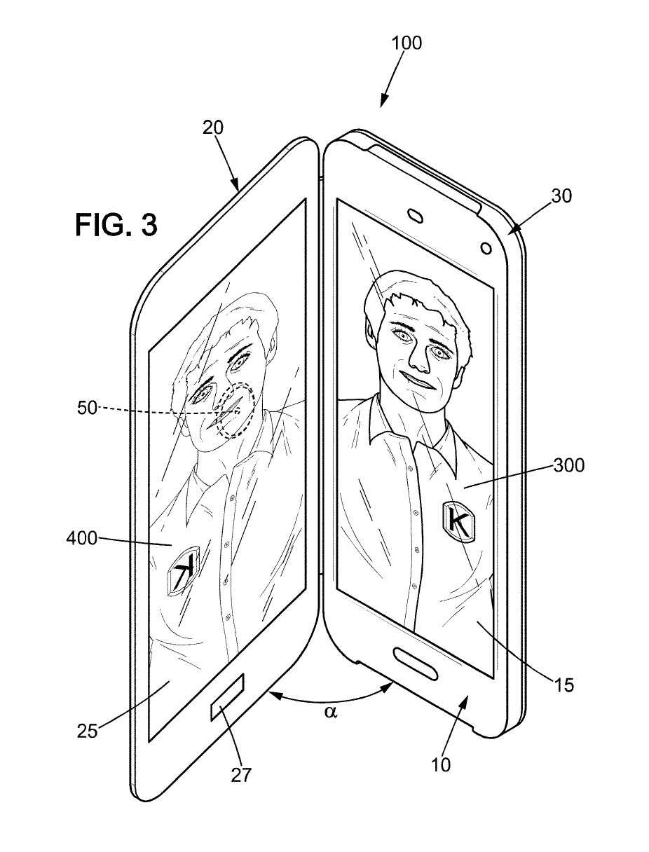

FIGS. 3 to 5 show details of one embodiment of a photographic device according to the invention;

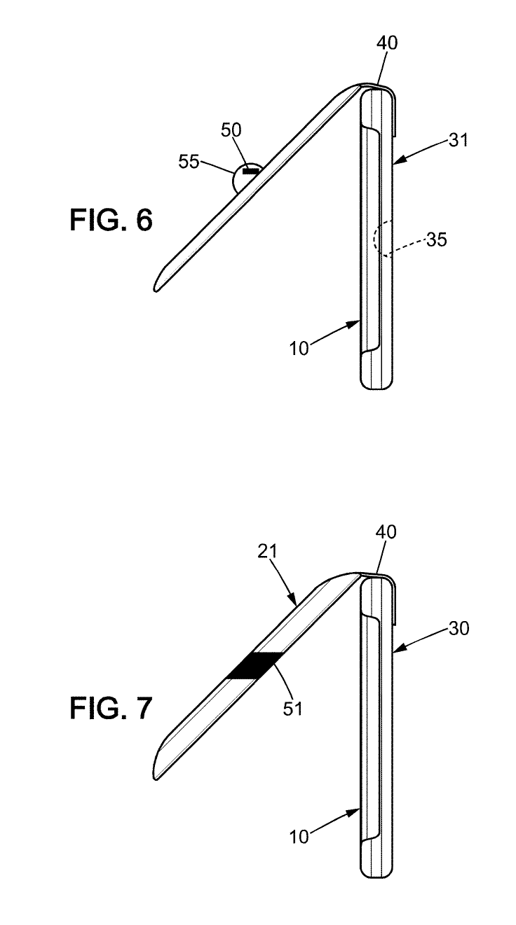

FIGS. 6 and 7 show other embodiments of a photographic device according to the invention.

It should be noted that the proportions of the components of the device shown are not necessarily adhered to and that the only function of the figures is to facilitate the understanding of the present invention. Identical numerical references correspond to the same components shown in the various figures.

FIGS. 1 and 2 show a subject 200 taking a photo of themselves with a photographic device 100 according to the present invention. The subject 200 can be seen in FIG. 1 holding said photographic device 100 at the end of one arm and the gaze of the subject is directed toward said device. FIG. 2 allows the main components of said photographic device to be identified. For reasons of simplification of the drawing, the arm of the subject has not been shown, but it should be imagined that, here again, the subject holds the photographic device at the end of their arm.

The photographic device 100 comprises:
a cellular telephone 10 equipped with a screen 15; this screen is associated with a device for displaying an image on said screen;
an image capture device 50 configured for capturing an image along an optical axis AO and for transmitting this image to the device for displaying an image; according to one embodiment, the optical axis is the optical axis of a main lens forming a part of the image capture device 50;
a mirror surface 25 configured so as to be able to be disposed facing the screen 15 in such a manner as to reflect an image displayed on the screen 15, said mirror surface being designed to allow an image to be captured by the image capture device 50 through a central part of the mirror surface 25.

The image capture device 50 is thus disposed behind the mirror surface 25 when the subject 200 is situated in front of the photographic device 100 and they are able to see their image reflected by the mirror surface 25.

Furthermore, the photographic device 100 comprises a protection case which comprises a part 30 into which the cellular telephone 10 is inserted, a mobile part 20, in the form of a flap, together with an articulation device 40 which allows the flap 20 to be articulated with the part 30. In this embodiment, the mirror surface 25 is disposed on the mobile part 20. The mirror surface 25 may be a surface of a mirror or of any device capable of reflecting an image produced by the screen 15. By way of example, this mirror surface may be a metal reflecting layer. The mirror surface may reflect the entirety of the light that it receives or else be partially reflecting and allow light to pass through it; the reflecting layer is then referred to as partially transparent. As examples of partially transparent reflecting layer, a one-way mirror or stacks of layers of another nature capable of reflecting a part of the incident light and of allowing most of the complementary (non-reflected) part of the incident light to pass through. In the case where the mirror surface reflects the entirety of the light that it receives, a region facing the image capture device 50 is arranged in order that at least a part of the light is able to pass through the mirror surface and allow a photo to be taken through said region by means of the image capture device; according to one embodiment, this region is an opening formed in the mirror surface; according to another embodiment, this region is composed of a reflecting layer which is partially transparent. The image capture device 50 comprises an image sensor and at least one lens; this image capture device allows still or video images to be acquired; such a capture device is usually referred to as a ‘camera’. In the embodiment shown, the image capture device 50 is protected by an enclosure 55 which is fixed to the back face of the flap 20.

Reference is made to FIG. 3, taken in relation with FIGS. 1 and 2, for more details on the images captured and generated by virtue of the photographic device 100 according to the present invention.

The image capture device 50 captures an image of the subject 200 through the mirror surface 25; this image of the subject is transmitted to the device for displaying an image and it is displayed by the display device on the screen 15. In the embodiment shown, the image 300 displayed on the screen 15 is the image captured by the image capture device 50; according to another embodiment, the image 300 displayed on the screen 15 is the mirror image of the image captured by the image capture device 50. The image 300 displayed on the screen 15 is reflected by the mirror surface 25 so as to form an image 400. This image 400 is seen by the subject who can thus choose their posture and/or their expression so as to produce a flattering selfie.

According to one embodiment, the image of the subject captured by the image capture device comprises the eyes of the subject. According to one embodiment, the gaze of the subject is directed toward the mirror surface 25. According to one embodiment, the average gaze line of the subject and the optical axis OA of the image capture device 50 are separated by an angle less than or equal to 15°.

In the embodiment shown in FIGS. 1 to 3, the head 210 of the subject 200 is oriented facing the image capture device 50 and the subject is looking straight in front, along the optical axis OA of the image capture device 50.

The average gaze line of the subject is defined as the axis passing in the middle of their eyes 211, 212 and passing through the point where their eyes converge.

According to one embodiment, the optical axis AO of the image capture device is situated between 30° and 60° from the normal to the mirror surface 25. In the embodiment shown in FIGS. 1 to 3, the optical axis AO of the image capture device is situated at 45° from the normal to the mirror surface 25.

In the embodiment shown in FIGS. 1 to 3, the angle α between the mobile part 20 and the screen 15 is 45°. In order to facilitate the vision of the subject, an angle α between the mobile part 20 and the screen 15 may for example be chosen in the range between 30° and 60°. This angle may be obtained for example by virtue of an angular separation device between the screen 15 and the mirror surface 25, which device may for example comprise notches, or any means enabling adjustment of an angular separation.

According to the embodiment shown, a means 27 for triggering the image capture device 50 is provided on the flap 20, in such a manner as to be easily activatable by a finger of the subject.

According to the embodiment shown, the mirror surface 25 has a surface identical to the surface of the screen 15.

According to the embodiment shown, the mirror surface 25 and the screen 15 have a rectangular shape with a width, Larg, and a length, Long. The image capture device 50 is situated in the middle of the width of the mirror surface 25, at Larg/2, and at two thirds of the length of the mirror surface 25, at 2·Long/3.

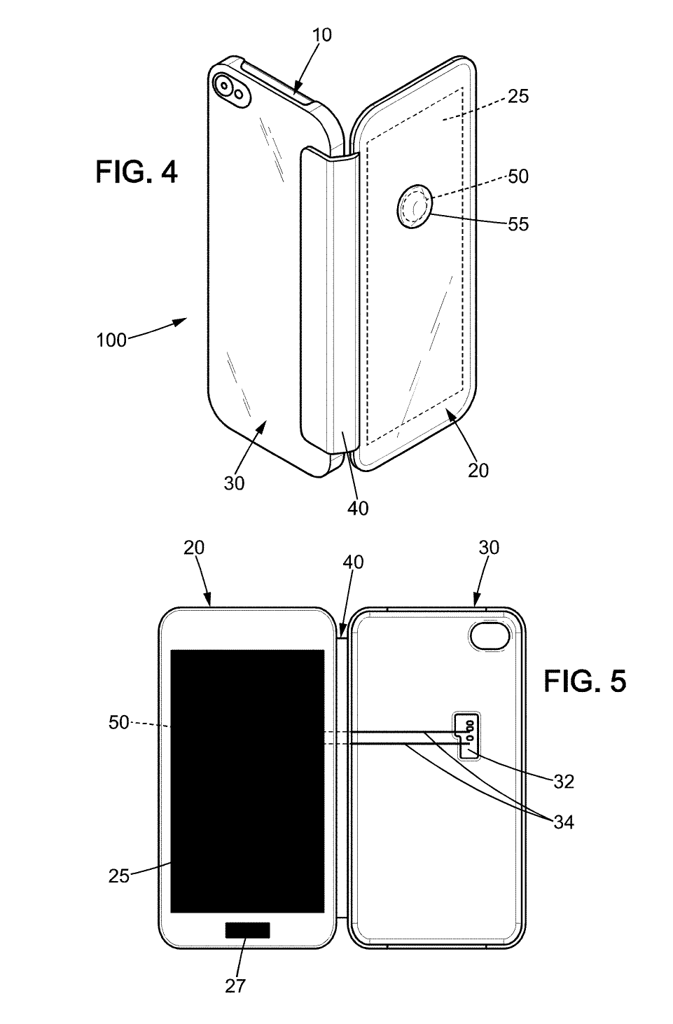

FIGS. 4 and 5 show other details of the embodiment of a photographic device corresponding to FIG. 3. FIG. 4 shows a diagram of the photographic device seen from the rear, from the side opposite to that shown in FIG. 3. The articulation device 40 and the enclosure 55 which protects the image capture device 50 can thus clearly be seen. FIG. 5 shows a diagram of the protection case comprising the flap 20 and the part 30 into which the cellular telephone 10 is inserted. Electrical wires 34 are disposed between the image capture device 50 and connections 32 disposed on the internal part of the part 30 in order to allow transfer of data. In this embodiment, the cellular telephone 10 comprises connections compatible with the connections 32 in such a manner that data may be exchanged by virtue of these connections.

The image capture device 50 and the device for displaying an image can exchange signals with each other in wired mode (for example according to a protocol UART (for “Universal Asynchronous Receiver Transmitter”) or SPI (for “Serial Peripheral Interface”) or I2C (for “Inter-Integrated Circuit”)) or in wireless mode by virtue of a communications interface (for example according to a protocol chosen from amongst the short-distance telecommunications protocols Bluetooth, Zigbee, Wifi, Lifi, ANT).

FIGS. 6 and 7 show other embodiments of a photographic device according to the invention.

FIG. 6 presents one embodiment close to that previously described, where a cavity 35 is provided for receiving the enclosure 55 which protects the image capture device 50. This cavity may only be situated in the part 31 into which the cellular telephone 10 is inserted. It may also be situated both in the part 31 into which the cellular telephone 10 is inserted and in the back of this cellular telephone 10.

Generally speaking, cameras with small dimensions may be chosen as image capture device 50, in such a manner that the space occupied resulting from the installation of this camera is small enough so as not to interfere with the general configuration of the cellular telephone 10. In this respect, it will be evident that the dimensions of the image capture device 50 depicted in the figures are, in general, exaggerated relative to the other components of the photographic device 100 with the sole aim of facilitating the understanding of the present invention.

FIG. 7 presents one embodiment where the image capture device 51 is disposed entirely inside of the mobile part 21, which takes the form of a flap. In the diagram shown, the image capture device 51, seen in cross section, has the shape of a rhombus and the optical axis of said device is disposed in the same direction as that of the preceding figures.

According to one embodiment, which may notably be implemented with embodiments corresponding to those exemplified in FIGS. 2 to 6, the image capture device is associated with a displacement device allowing the image capture device and/or the optical axis of the image capture device to be oriented. Such a displacement device may be actuated by micro-motors, for example by microelectromechanical systems, known under the acronym MEMS, or under MST (for MicroSystems Technology). It is thus possible to vary, preferably slightly, the optical axis and to choose a photo shooting direction when the photo is taken. Such a displacement device may also be implemented with the embodiment corresponding to FIG. 7.

According to one embodiment, which may notably be implemented with any one of the embodiments previously exemplified, the image capture device 50 may be oriented toward the rear by disposing the flap 20 at around 270° from the position shown in FIG. 2, 6 or 7. It is then possible to take photos in a direction opposite to the eyes of the subject. Such an implementation may be so as to render superfluous a camera disposed on the cellular telephone 10. Furthermore, the image capture toward the rear or in another direction may be facilitated in the case where the image capture device is associated with a displacement device allowing the image capture device and/or the optical axis of the image capture device to be oriented.

It goes without saying that the invention is not limited to the embodiments previously described and provided solely by way of example. It encompasses various modifications, alternative forms and other variants that may be envisioned by those skilled in the art in the framework of the present invention and notably all combinations of the various modes of operation previously described, which may be taken separately or in association.

1-15. (canceled)

16. A photographic device comprising:
a cellular telephone or a tablet equipped with a screen associated with a device for displaying an image on said screen;
an image capture device configured for capturing an image along an optical axis and for transmitting this image to the device for displaying an image;
a mirror surface configured so as to be able to be disposed facing the screen in such a manner as to reflect an image displayed on the screen, said mirror surface being designed to allow an image to be captured by the image capture device through a central part of the mirror surface.

17. The photographic device as claimed in claim 16, where the mirror surface capable of being positioned facing the screen is disposed on a mobile part attached to the cellular telephone or to the tablet via an articulation device.

18. The photographic device as claimed in claim 16, where the mobile part attached to the cellular telephone or to the tablet is a flap of a protection case into which the cellular telephone or the tablet is inserted.

19. The photographic device as claimed in claim 16, where the mirror surface capable of being positioned facing the screen is obtained by a partially transparent reflecting layer.

20. The photographic device as claimed in claim 16, where the mirror surface capable of being positioned facing the screen is obtained by a reflecting layer through which an opening is formed in such a manner as to allow an image to be captured through said opening by virtue of an image capture device.

21. The photographic device as claimed in claim 16, where the mirror surface has substantially the size of the screen.

22. The photographic device as claimed in claim 16, where the mirror surface has a rectangular shape with a width, Larg, and a length, Long, and where the central part of the mirror surface is bounded by a rectangle centered on the point (Larg/2, 2·Long/3) and with a width of the short side equal to Larg/2 and with a length of the long side equal to Long/2.

23. The photographic device as claimed in claim 16, where the optical axis of the image capture device is situated between 30° and 60° from the normal to the mirror surface.

24. The photographic device as claimed in claim 16, where the image capture device is associated with a displacement device allowing the image capture device and/or the optical axis of the image capture device to be oriented.

25. The photographic device as claimed in claim 16 comprising a device for angular separation between the screen and the mirror surface, designed to allow an angular separation, α, between the screen and the mirror surface, in the range between 30° and 60°.

26. A method for capturing a photographic image where a subject uses the photographic device as claimed in claim 16 and where:
the image capture device captures an image of the subject and transmits this image to the device for displaying an image;
the image is displayed by the display device on the screen;
the mirror surface is disposed facing the screen in such a manner as to reflect the image of the subject displayed on the screen.

27. The method for capturing a photographic image as claimed in claim 26 where the image of the subject captured by the image capture device comprises the eyes of the subject.

28. The method for capturing a photographic image as claimed in claim 27 where the gaze of the subject is directed toward the mirror surface.

29. The method for capturing a photographic image as claimed in claim 28 where the average gaze line of the subject and the optical axis of the image capture device are separated by an angle less than or equal to 15°.

30. The method for capturing a photographic image as claimed in claim 26 where the image displayed by the display device on the screen is a mirror image of the image captured by the image capture device.

31. The photographic device as claimed in claim 31, where the mirror surface capable of being positioned facing the screen is a reflecting surface of a one-way mirror.

32. The photographic device as claimed in claim 31, where the mirror surface has a surface area in the range between 80% and 120% of the surface area of the screen.

33. A method for capturing a photographic image where a subject uses the photographic device as claimed in claim 17 and where:
the image capture device captures an image of the subject and transmits this image to the device for displaying an image;
the image is displayed by the display device on the screen;
the mirror surface is disposed facing the screen in such a manner as to reflect the image of the subject displayed on the screen.

34. A method for capturing a photographic image where a subject uses the photographic device as claimed in claim 18 and where:
the image capture device captures an image of the subject and transmits this image to the device for displaying an image;
the image is displayed by the display device on the screen;
the mirror surface is disposed facing the screen in such a manner as to reflect the image of the subject displayed on the screen.

35. A method for capturing a photographic image where a subject uses the photographic device as claimed in claim 19 and where:
the image capture device captures an image of the subject and transmits this image to the device for displaying an image;
the image is displayed by the display device on the screen;
the mirror surface is disposed facing the screen in such a manner as to reflect the image of the subject displayed on the screen.
